(19) United States
(12) Patent Application Publication
(10) Pub. No.: US 2020/0301566 A1
(43) Pub. Date: Sep. 24, 2020

(54) ENVIRONMENTAL CONTEXT BASED EMOJI SELECTION IN COMPUTING DEVICES

(71) Applicant: Microsoft Technology Licensing, LLC, Redmond, WA (US)

(72) Inventor: Stephanie Monk, Redmond, WA (US)

(21) Appl. No.: 16/362,557

(22) Filed: Mar. 22, 2019

(51) Int. Cl. G06F 3/0481; G06F 3/0483; H04W 4/02; G06F 17/10

(52) U.S. Cl. CPC G06F 3/04817; G06F 17/10; H04W 4/025; G06F 3/0483

(57) ABSTRACT

Techniques for managing user interfaces for selecting emojis are disclosed herein. In one embodiment, a method includes in response to receiving a user request, retrieving current values of one or more of a date, a time, or a location of the computing device from an operating system. The method also includes identifying one or more of the multiple emojis having highest frequency of use among all the available emojis at the current values of date, time, or location of the computing device and surfacing, on a display of the computing device, the one or more emojis having the highest frequency of use in a user interface.

### BACKGROUND

Today, emojis have become common place in electronic communications both in casual and in professional environments. Emojis are small digital images, pictures, or icons often used in emails, instant messages, or text messages to express or represent ideas, emotions, objects, or meanings. For example, a smiling face emoji can be used to express happiness. On the other hand, a frowny face emoji can be used to express sadness. Other emojis can also be used to express or represent additional facial expressions, objects, places, types of weather, animals, etc.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

To facilitate efficient composition of emails, instant messages, text messages, or other suitable types of electronic messages, computing systems can provide certain applications to facilitate selection of emojis by users via pages. Such applications are generally referred to as emoji pickers. In certain emoji pickers, different emojis are grouped for display into different tabs, sections, panes, windows, or other suitable types of user interface elements (collectively referred to herein as “pages”). For instance, a facial expression page can include emojis of various facial expressions. A food item page can include emojis of ice cream, pizza, soda, pasta, and other food items. When composing an electronic message, a user can browse through multiple pages to locate, select, and insert emojis into electronic messages. Certain emoji pickers can also track emojis previously selected and/or inserted by users into electronic messages and group these emojis in a frequently used page. Certain emoji pickers can also provide a search field that allows a user to query all the pages for emojis using keywords (e.g., “ice cream”) or other suitable search criteria.

Grouping emojis in the foregoing manners, however, may not allow users to efficiently locate emojis when composing electronic messages. For example, during November and December, a user may browse for emojis often associated with the Thanksgiving and Christmas holiday season, such as emojis for turkeys, Santa Claus, reindeer, sleigh, snowman, etc. These emojis, however, may be located in different pages based on corresponding categories. For instance, emojis of turkeys may be located in an animal or food page while emojis of Santa Claus may be located in a person page. As such, a user may spend a long time browsing through multiple emoji pages in order to locate all desired emojis for composition of a holiday electronic message. In another example, when a user first starts using an emoji picker, the frequently used page would be empty. Only after a period of usage, the frequently used page can be populated with previously selected emojis after browsing through multiple emoji pages. Facilitating a user's browsing through multiple emoji pages can place a heavy burden on a computing load and/or network bandwidth consumption of the computing device.

Several embodiments of the disclosed technology can address at least some of the foregoing drawbacks by implementing an emoji picker having one or more pages (referred to herein as “context pages”) configured to provide emojis suggested based on environmental context data. In certain embodiments, the environmental context data can include data representing one or more of a date, a time, a season, or a location, and/or other suitable environment parameters related to an environment in which a user or a corresponding computing device executing the emoji picker is located. For example, the emoji picker can be configured to provide a context page that displays multiple emojis related to Thanksgiving and Christmas holiday season when the emoji picker determines that a current date is within a date range, e.g., from November 1 to December 31. In another example, the emoji picker can also provide a context page that displays multiple emojis related to summer activities (e.g., surfing, sunbathing, etc.) when the emoji picker determines that a current date is from within another date range, such as June 15 to September 10.

In other examples, the emoji picker can also be configured to provide one or more context pages having selected emojis based on a location or a season at the location of the user or computing device in addition to or in lieu of a current date or time. For instance, when the emoji picker determines that a current date is within a date range from November 1 to December 31 but a current location is Australia, the emoji picker can be configured to provide a context page that includes emojis for summer activities (e.g., swimming) instead of winter activities (e.g., skiing) in addition to emojis for Santa Claus and Christmas trees. In another example, when the emoji picker determines that a current date is within a date range from January 10 to February 15 and a current location is China, the emoji picker can be configured to provide a context page that includes emojis for Chinese Spring Holiday (e.g., fire crackers). In further examples, the emoji picker can also be configured to filter emojis in existing and/or context pages based on a current location of the user or computing device in accordance with local traditions. For instance, emojis for beef may be removed from any of the pages when the current location is India.

Association of emojis with certain date, time, location, and/or season can be developed in various ways in accordance with aspects of the disclosed technology. In one embodiment, a software developer of the emoji picker can manually configure the association via rules, decision trees, and/or other suitable techniques. For instance, an example rule can include data that indicates that a Santa Claus emoji is associated with a date range (e.g., November 1 to December 31) and a particular location (e.g., North America) of the user or computing device. Such manually configured rules can also be updated periodically via software updates or other suitable techniques.

In other embodiments, such association can be generated and updated based on monitored emoji usage at a location in which the computing system is located during certain dates, times, seasons, or other time periods. For example, data representing used emojis (referred to below as “emoji usage data”) in text messages in a cellular network may be collected as anonymous data and/or with user consent. The emoji usage data can then be analyzed to determine usage patterns and/or correlations of used emojis and a date, a time, a location, and/or other suitable environmental parameters. As such, a model developer can be configured to develop an emoji model that can be used to predict a probability that an emoji is likely to be used based on a date/time, a date/time range, a location, and/or other suitable environmental parameters.

In some implementations, the emoji model can include data representing a set of weight values corresponding to various environment parameters and a decision tree derived via machine learning. For example, the model developer can be configured to identify the various weight values using a “neural network” or “artificial neural network” configured to “learn” or progressively improve performance of tasks by studying known examples. In certain implementations, a neural network can include multiple layers of objects generally refers to as “neurons” or “artificial neurons.” Each neuron can be configured to perform a function, such as a non-linear activation function, based on one or more inputs via corresponding connections. Artificial neurons and connections typically have a contribution value that adjusts as learning proceeds. The contribution value increases or decreases a strength of an input at a connection. Typically, artificial neurons are organized in layers. Different layers may perform different kinds of transformations on respective inputs. Signals typically travel from an input layer, to an output layer, possibly after traversing one or more intermediate layers. In some implementations, the model developer can also be configured to update the emoji model using additional emoji usage data. In other embodiments, the model developer can be configured to perform such model development and/or update based on administrator provided rules or via other suitable techniques.

In additional embodiments, the environmental context data can also include data representing user's activities collected from user's calendars, social network posting, etc. with suitable user consent. For instance, a user's calendar items can be monitored in a corporate environment to provide a context page of emojis selected based on activities corresponding to the monitored calendar items. In one example, a user can have a calendar item for a scheduled bowling night. In response, the emoji picker can be configured to provide a context page having emojis representing bowling alleys, bowling pins, etc. In another example, a user can have a calendar item for a vacation in Paris France. In response, the emoji picker can be configured to provide another context page having emojis of Eiffel tower, Arc de Triomphe, etc. In other examples, a user's social network postings, sports activities, personal interests provided by the user, and/or other suitable information can also be used to generate and output to the user context pages with corresponding emojis.

Several embodiments of the disclosed technology can thus provide a user interface that allows users to efficiently locate, select, and insert emojis into electronic messages. In certain embodiments, the emoji picker can be configured to select emojis based on environmental context data and provide the selected emojis in a context page separate from other pages. For example, an emoji model can be used to calculate a probability that an emoji is likely to be used based on the various environment parameters. Upon determining that the probability is above a threshold, the emoji can be added to the context page. As such, the emojis in the context page can be more relevant to the user based on the current date, time, location, and/or other environment parameters. Thus, time spent by the user to browse through and locate desired emojis may be reduced to improve user experience. In addition, by providing an efficient context page to allow the user to locate desired emojis, a computing load and/or network bandwidth consumption of the computing device may be reduced to improve performance of the computing device.

### BRIEF DESCRIPTION OF THE DRAWINGS

FIGS. 1A-1C are schematic diagrams illustrating a computing system implementing environmental context-based emoji selection during certain stages of operation in accordance with embodiments of the disclosed technology.

FIG. 2 is a schematic diagram illustrating hardware/software components of a model developer in accordance with embodiments of the disclosed technology.

FIGS. 3A-3C are flowcharts illustrating processes of environmental context-based emoji selection in accordance with embodiments of the disclosed technology.

FIG. 4 is a computing device suitable for certain components of the computing system in FIGS. 1A-1C.

### DETAILED DESCRIPTION

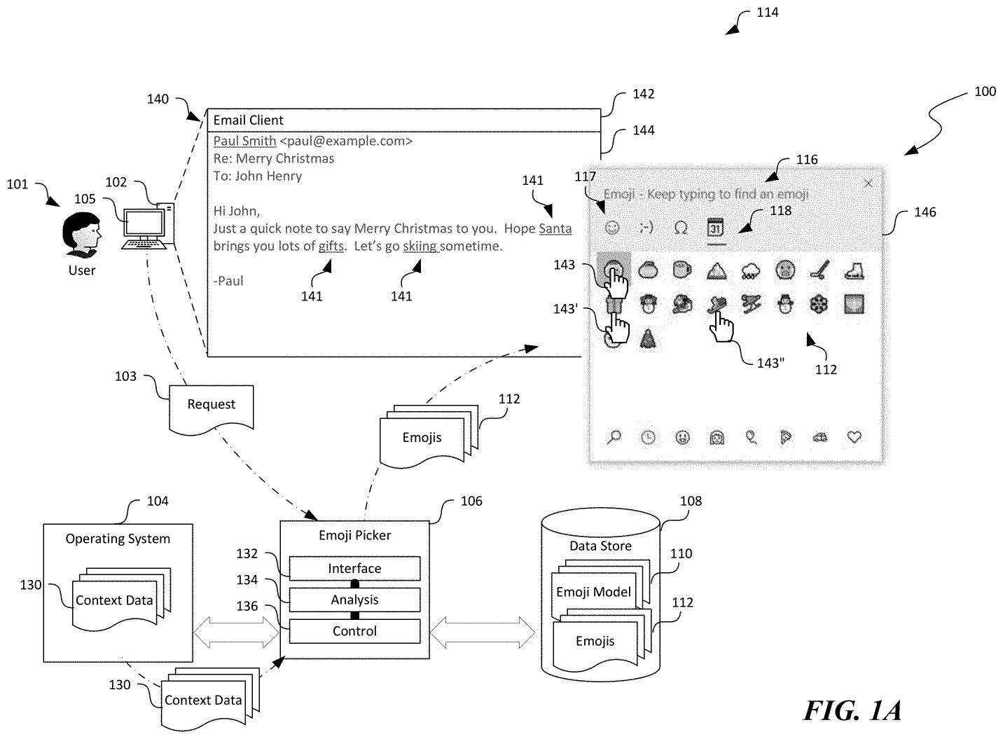

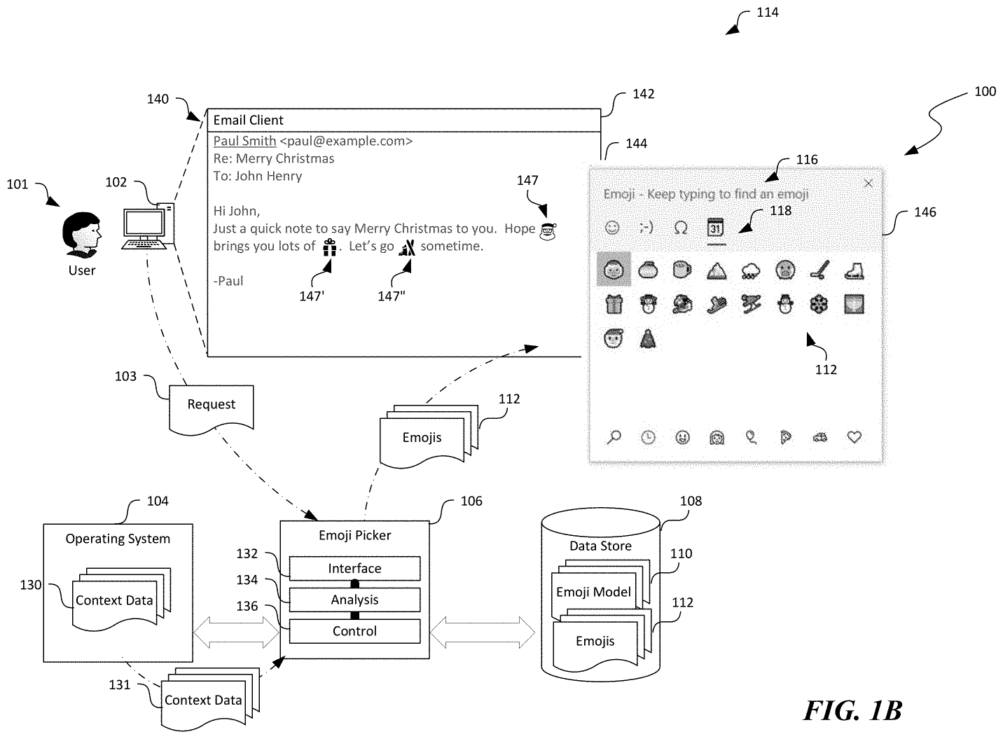

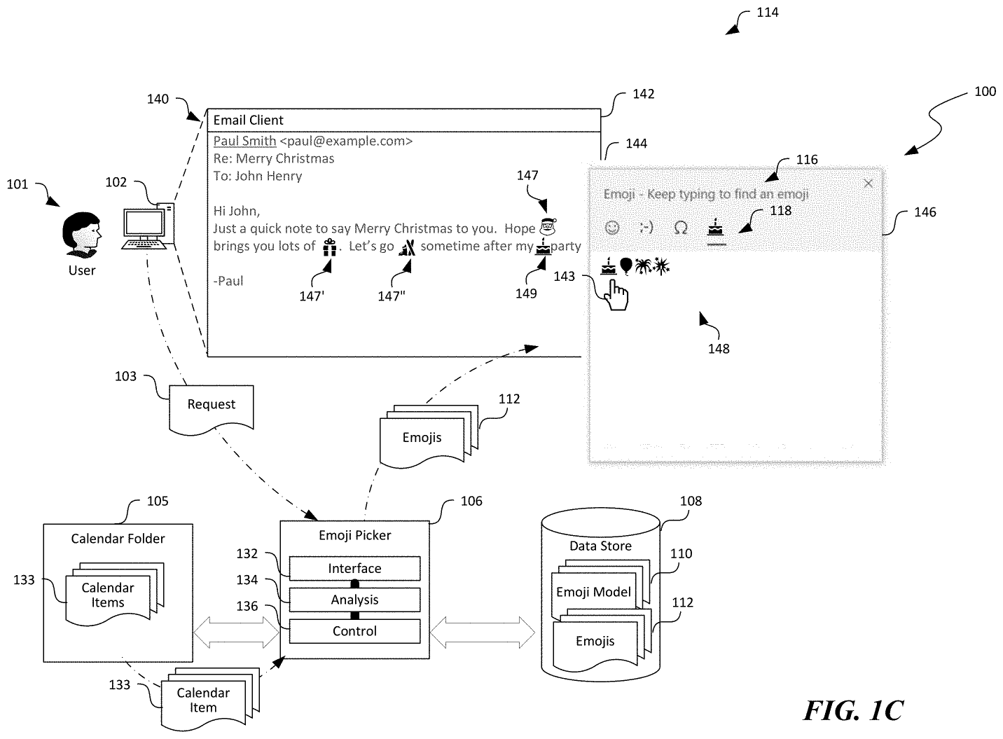

Certain embodiments of systems, devices, components, modules, routines, data structures, and processes for environmental context-based emoji selection in computing devices are described below. In the following description, specific details of components are included to provide a thorough understanding of certain embodiments of the disclosed technology. A person skilled in the relevant art will also understand that the technology can have additional embodiments. The technology can also be practiced without several of the details of the embodiments described below with reference to FIGS. 1A-4.

As used herein, the term “emoji” generally refers to digital images, pictures, or icons usable in emails, instant messages, text messages, or other suitable types of electronic messages to express or represent ideas, emotions, objects, or meanings. Emojis can be encoded using various encoding standards such as Unicode. For example, a grinning face emoji can have a Unicode of U+1F600. In another example, a thumbs up emoji can have a Unicode of U+1F44D. Also used herein, an “emoji interface” generally refers to a space surfaced on a display (e.g., a screen) of a computing device where interactions between humans and the computing device. Emoji interfaces can include one or more tabs, sections, panes, windows, or other suitable types of user interface elements (collectively referred to herein as “pages” or “emoji pages”). Each page can be configured to contain and display one or more emojis according to categories, frequency of use, and/or other suitable criteria.

Also used herein, “environmental context data” or “context data” generally refers to data representing various circumstances of a user and/or a computing device associated with the user. For example, environmental context data can include data representing one or more of a date, a time, a season, or a location, and/or other suitable environment parameters related to an environment in which a user or a corresponding computing device executing the emoji picker is located. In other examples, environmental context data can also include data representing personal interest of a user, activities of a user as reflected from calendar items, social network postings, or other suitable sources.

Further used herein, a “context page” generally refers to a page or an emoji page in an emoji interface that is configured to provide emojis suggested based on environmental context data of a user and/or a computing device associated with the user. For example, a context page can be configured to display emojis related to Thanksgiving and Christmas holiday season when a current date is within a date range, e.g., from November 1 to December 31. In another example, a context page can be configured to display emojis related to summer activities (e.g., surfing, sunbathing, etc.), food items (e.g., ice cream), weather conditions (e.g., sunshine), or other suitable emojis when a current date is from within another date range, such as June 15 to September 10.

Also used herein, an “emoji picker” generally refers to a software application configured to surface an emoji interface on a display of a computing device. The software application can also be configured to provide facilities for browsing through pages of the emoji interface, accepting a user input to select emojis from the pages of the emoji interface, and inserting the selected emojis into an email, instant message, text message, or other suitable types of electronic messages. One example emoji picker is iPhone Emoji Keyboard provided by Apple, Inc. of Mountain View, California.

Certain emoji pickers can provide multiple pages of emojis grouped according to categories. For example, a facial expression page can include emojis of various facial expressions. A food item page can include emojis of ice cream, pizza, soda, pasta, and other food items. Certain emoji pickers can also provide a frequently used page that contains emojis previously used by users. Grouping emojis in the foregoing manners, however, can be inconvenient for users to locate desired emojis when composing electronic messages. For example, during November and December, a user may browse for emojis often associated with the Thanksgiving and Christmas holiday season, such as emojis for turkeys, Santa Claus, reindeer sleigh, snowman, etc. These emojis, however, may be located in different pages based on corresponding categories. For instance, emojis of turkeys may be located in an animal or food page while emojis of Santa Claus may be located in a person page. As such, a user may spend a long time browsing through multiple emoji pages in order to locate all desired emojis for composition of a holiday electronic message. In another example, when a user first starts using an emoji picker, the frequently used page would be empty. Only after a period of usage, the frequently used page can be populated with previously selected emojis after browsing through multiple emoji pages. Facilitating a user's browsing through multiple emoji pages can place a heavy burden on a computing load and/or network bandwidth consumption of the computing device.

Several embodiments of the disclosed technology can address at least some of the foregoing drawbacks by implementing an emoji picker having one or more context pages configured to provide emojis suggested based on environmental context data. For example, a context page can be configured to provide multiple emojis related to the Thanksgiving and Christmas holiday season based on a current date associated with a user and/or a computing device of the user. Thus, in response to determining that a current date is within a date range, e.g., from November 1 to December 31, the emoji picker can surface the context page related to Thanksgiving and Christmas holiday season to allow the user to efficiently and conveniently select desired holiday emojis. Thus, time spent by the user to browse through and locate desired emojis may be reduced to improve user experience. In addition, by providing the context page to allow the user to locate desired emojis, a computing load and/or network bandwidth consumption of the computing device may be reduced to improve performance of the computing device, as described in more detail below with reference to FIGS. 1A-4.

FIGS. 1A-1C are schematic diagrams illustrating a computing system 100 implementing environmental context-based emoji selection during certain stages of operation in accordance with embodiments of the disclosed technology. In FIG. 1A and in other Figures herein, individual software components, objects, classes, modules, and routines may be a computer program, procedure, or process written as source code in C, C++, C#, Java, and/or other suitable programming languages. A component may include, without limitation, one or more modules, objects, classes, routines, properties, processes, threads, executables, libraries, or other components. Components may be in source or binary form. Components may include aspects of source code before compilation (e.g., classes, properties, procedures, routines), compiled binary units (e.g., libraries, executables), or artifacts instantiated and used at runtime (e.g., objects, processes, threads).

Components within a system may take different forms within the system. As one example, a system comprising a first component, a second component and a third component can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a network server, a laptop computer, a smartphone, and/or other suitable computing devices.

Equally, components may include hardware circuitry. A person of ordinary skill in the art would recognize that hardware may be considered fossilized software, and software may be considered liquefied hardware. As just one example, software instructions in a component may be burned to a Programmable Logic Array circuit or may be designed as a hardware circuit with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media excluding propagated signals.

As shown in FIG. 1A, the computing system 100 can include a computing device 102 having an operating system 104, an application 140, and an emoji picker 106. As shown in FIG. 1A, the operating system 104 can contain records of context data 130 such as a system date/time, a location of the computing device 102 (e.g., by accessing a GPS module of the computing device 102, not shown), and/or other suitable information. In other embodiments, the operating system 104 can also be configured to retrieve and/or update the context data 130 via a computer network, cellular network, and/or other suitable channels. An example operating system suitable for the computing device 102 can include iOS provided by Apple Inc. of Mountain View, California, or Android provided by Google LLC of Menlo Park, Calif.

Even though the application 140 and the emoji picker 106 are shown as a software component executed on the computing device 102 in FIG. 1A, in other embodiments, the emoji picker 106 can also be executed on a remote server (not shown) to provide a corresponding computing service via a computer network (e.g., the Internet). In additional embodiments, the computing system 100 can also include a cellular network (not shown) and corresponding remote servers (not shown) interconnected to the computing device 102 for providing various communications or other suitable services to the computing device 102.

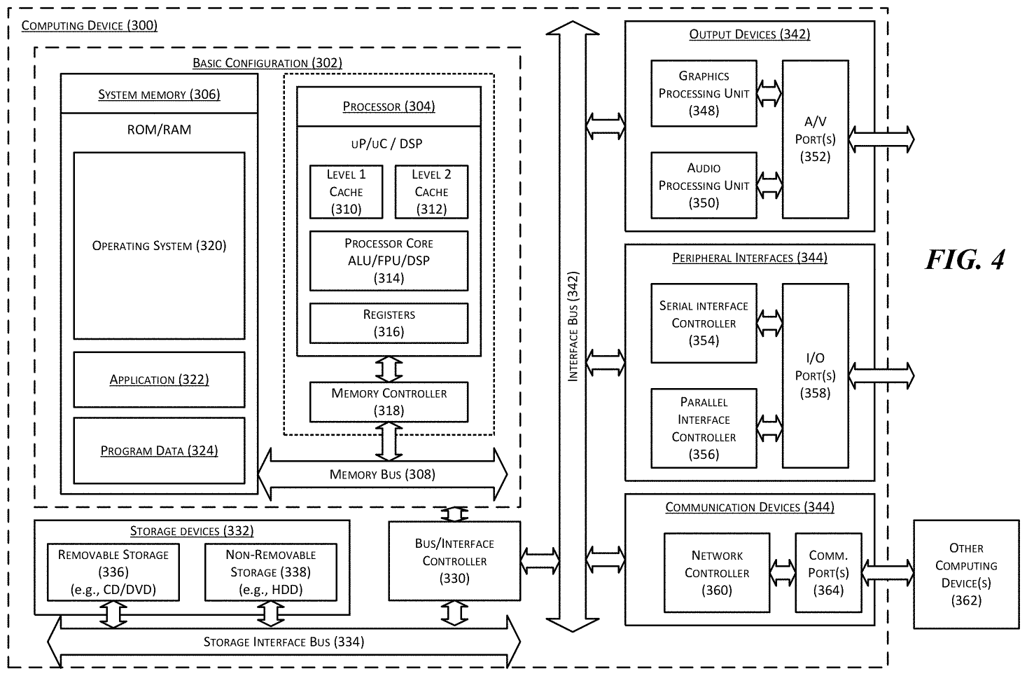

The computing device 102 can be configured to facilitate the user 101 to perform various tasks. For example, the computing device 102 can facilitate the user 101 to compose emails, instant messages, text messages or other suitable types of electronic messages. In other examples, the computing device 102 can also facilitate the user 101 to perform various computational, communication, or other suitable types of tasks. In the illustrated embodiment, the computing device 102 includes a desktop computer having one or more processors 304 (shown in FIG. 4), a system memory 306 (shown in FIG. 4), and a display 105 (e.g., a touchscreen) operatively coupled to one another. In other embodiments, the computing device 102 can also include a laptop computer, a tablet, a smartphone, or other suitable types of electronic device with additional and/or different hardware/software components.

The one or more processors 304 of the computing device 102 can be configured to execute suitable instructions to provide the operating system 104, the application 140, and the emoji picker 106. For instance, as shown in FIG. 1A, the application 140 can include an email client configured to provide the user 101 (e.g., “Paul Smith”) with a user interface 142 for composing an email 144 to another person (e.g., “John Henry”). In other examples, the application 140 can also include a text message application, an instant message application, a word processor, or other suitable types of application.

In the illustrated example in FIG. 1A, the email 144 is regarding the Christmas holiday. In particular, the user 101 writes in the email 144 with the following:
Hi John,
Just a quick note to say Merry Christmas to you. Hope Santa brings you lots of gifts. Let's go skiing sometime.
Paul
   In the foregoing example email 140, the user 101 may desire to replace some of the text with emojis. For instance, the user 101 may desire to replace “Santa,” “gifts,” and “skiing” with emojis. Thus, the user 101 can provide an input representing a request 103 to launch the emoji picker 106.

In response to receiving the request 103, the emoji picker 106 can be configured to provide an emoji interface 146 that facilitate the user 101 to locate, select, and insert one or more emojis 112 into the email 144. As shown in FIG. 1A, the emoji picker 106 is operatively coupled to a data store 108 containing records of an emoji model 110 and emojis 112. In certain implementations, the data store 108 can be located at the computing device 102, for instance, as digital data in a non-volatile computer-readable storage medium at the computing device 102. In other implementations, the data store 108 can be located at a remote source (e.g., a cloud storage) and accessible to the emoji picker 106 via a computer network such as the Internet. In further implementations, at least one of the emoji model 110 or the emojis 112 can be located at the remote source while other emojis 112 are located at the computing device 102.

The emoji model 110 can include data representing correlations of the one or more emojis 112 and the one or more environmental parameters of the user 101 and/or the computing device 102. In one example, the environmental parameters can include a current date and/or current location of the user 101 or computing device 102. In other examples, the other environmental parameters can include a current time, a current season, activities of the user 101, and/or other suitable parameters. In certain embodiments, the correlations in the emoji model 110 can be represented by multiple weight values corresponding to the individual environmental parameters for each emoji 112. Higher weight values may indicate a higher likelihood of use of an emoji 112 based on the corresponding environmental parameter. For instance, a weight value of 1.0 may be assigned to correspond to a current date for a Santa Claus emoji while another weight value of 0.5 may be assigned to the same Santa Claus emoji for a current location. The weight values can then be multiplied by values of the current date and current location to produce a contribution to a probability that the Santa Claus emoji is likely to be used. In other embodiments, such correlations can be represented as mathematically formulas, polynomials, and/or in other suitable ways.

The emoji model 110 can be developed in various ways in accordance with aspects of the disclosed technology. In one embodiment, a software developer of the emoji picker 106 can manually configure the correlations via rules, decision trees, and/or other suitable techniques. For instance, an example rule can include data that indicates that a Santa Claus emoji is associated with a particular date range (e.g., November 1 to December 31) and a particular location (e.g., North America) of the user or computing device. Such manually configured rules can also be updated periodically via software updates or other suitable techniques.

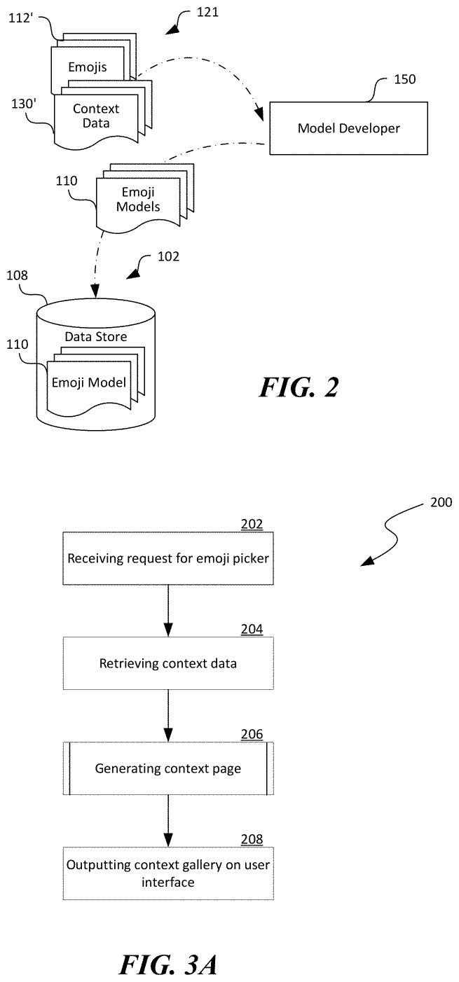

In other embodiments, such correlations can be generated and updated based on monitored emoji 112 usage at a location in which the computing device 102 is located during certain dates, times, seasons, or other time periods. For example, data representing used emojis 112 (referred to below as “emoji usage data”) in text messages in a cellular network may be collected as anonymous data and/or with user consent. The emoji usage data can then be analyzed to determine usage patterns and/or correlations of used emojis and a date, a time, a location, and/or other suitable environmental parameters. As such, a model developer 150 (shown in FIG. 2) can be configured to develop the emoji model 110 that can be used to predict a probability that an emoji 112 is likely to be used based on a date/time, a date/time range, a location, and/or other suitable environmental parameters, as described in more detail below with reference to FIG. 2.

As shown in FIG. 1A, the emoji picker 106 of the computing device 102 can include an interface component 106, an analysis component 134, and a control component 136 operatively coupled to one another. Even though particular components of the emoji picker 106 are shown in FIG. 1A, in other embodiments, the emoji picker 106 can also include network, database, or other suitable types of components.

The interface component 132 can be configured to interface with the operating system 104, the data store 108, and the other suitable components of the computing device 102. For example, the interface component 132 can be configured to receive the request 103 from the user 101. In response to receiving the request 103, the interface component 132 can be configured to retrieve the context data 130 from the operating system 104. The interface component 134 can then forward the request 103 and the retrieved context data 130 to the analysis component 134 for further processing.

The analysis component 134 can be configured to select one or more emojis 112 from the data store 108 based on the emoji model 110 and the context data 130. In one embodiment, the analysis component 134 can be configured to select a number of the emojis 112 having highest frequency of use in all of the emojis 112 at current values of date, time, or location of the computing device 102 as reflected in the retrieved context data. In another embodiment, the analysis component 134 can be configured to derive a sum of products of the current values of date, time, or location and corresponding weight values in the emoji model 110. The analysis component 134 can then determine whether the derived sum exceeds a threshold. In response to determining that the derived sum exceeds a threshold, the analysis component 134 can mark one of the emojis 112 as one of the selected one or more emojis 112. Otherwise, the emoji 112 can be omitted from the context page 118. In further embodiments, the analysis component 134 can be configured to sort the multiple emojis 112 according to respectively sums and select one or more of the multiple emojis 112 having highest sums indicating probability values from the sorted multiple emojis 112. In yet further embodiments, the analysis component 134 can be configured to select the one or more emojis 112 for the context page 118 in other suitable manners based on the context data 130.

The analysis component 134 can then provide the selected one or more emojis 112 for the context page 118 to the control component 136 for further processing. The control component 136 can be configured to generate a context page 118 of emojis 112 by grouping the selected one or more emojis 112 into the context page 118. Though only one context page 118 is shown in FIG. 1A for illustration purposes, in some implementations, the control component 136 can be configured to provide multiple context pages 118 (not shown). The control component 136 can then be configured to instruct the interface component 132 to provide records of the emojis 112 grouped in multiple pages 117 according to categories and the context page 119 to be surfaced on the display 105 of the computing device 102.

In the illustrated example in FIG. 1A, the emoji interface 146 includes a facial expression page, a short hand page, a symbol page, and the context page 118, and a search area 116 configured to search for an emoji 112 based on a user provided keyword. The context page 118 can include emojis 112 associated with the Christmas holiday season. For instance, the context page 118 (shown as a page identified by a calendar indicating a date of “31”) includes emojis of Santa Claus, Christmas trees, skiing, etc. In other examples, the emoji interface 146 can include additional and/or different interface elements than those shown in FIG. 1A while the context page 118 can include additional and/or different emojis 112.

The context page 118 can facilitate the user 101 to locate, select, and insert desired emojis 112 into the email 144. For instance, as shown in FIG. 1A, if the emoji interface 146 does not provide the context page 118, the user 101 may need to browse through multiple other pages 117 on the emoji interface 146 to locate emojis 112 for “Santa,” “gifts,” and “skiing.” In contrast, the context page 118 can provide all these desired emojis 112 in one place. As such, the user 101 can select (as represented by the cursors 143, 143′, and 143″) suitable emojis 112 for “Santa,” “gifts,” and “skiing” without browsing through the other pages 117 of the emoji interface 146. As shown in FIG. 1B, the selected emojis 112 can be inserted into the email 144.

Even though the examples shown in FIG. 1A and 1B illustrate generating and providing the context page 118 based on a current date/time and/or location, in other embodiments, the context page 118 can also be provided based on other suitable environmental context data. For example, as shown in FIG. 1C, the emoji picker 106 can have access, with permission from the user 101, to a calendar folder 105 either located at the computing device 102 or a remote location (e.g., a cloud server). The calendar folder 105 can contain records of calendar items 133, such as appointments for meetings, activities, vacations, etc.

Based on the information in the calendar items 133, the emoji picker 106 can be configured to generate and provide a corresponding context page 118. For example, a calendar item 133 of the user 101 retrieved by the interface component 132 from the calendar folder 105 may include an appointment for a birthday party. In response, the analysis component 134 can select one or more emojis 112 that are likely be used when discussing a birthday party. For example, as shown in FIG. 1C, the selected emojis 112 include emojis for birthday cases, balloons, and fireworks. By grouping such emojis 112 together and surface the emojis 112 in the context page 118, the emoji picker 106 can allow the user to efficiently locate and insert suitable emojis 112 into the email 144. For instance, the user 101 can insert the emoji of a birthday case into the email 144 to replace the text “birthday.” In other examples, information regarding the invitees related to the calendar item 133 can also be used as an environment parameter for selecting one or more emojis 112 to be included in the context page 118. For instance, when the user 101 composes a new email 144 to a person who's on the invite list for the birthday party as indicated in the calendar item 133, birthday/party-related emojis 112 may be given more weight. If the person is not on the invite list, birthday/party-related emojis 112 may be given less weight. In further examples, a duration, a location, or other suitable information included in the calendar item 133 can also be used as environment parameters when selecting the emojis 112 for the context page 118.

Several embodiments of the emoji picker 106 can thus provide an emoji interface 146 that allows the user 101 to efficiently locate, select, and insert emojis 112 into email 144. The emojis in the context page 118 can be more relevant to the user 101 based on the current date, time, location, activities related to the user 101, and/or other environment parameters. Thus, time spent by the user 101 to browse through and locate desired emojis 112 may be reduced to improve user experience. In addition, by providing an efficient context page 118 to allow the user to locate desired emojis, a computing load and/or network bandwidth consumption of the computing device 102 may be reduced to improve performance of the computing device 102.

FIG. 2 is a schematic diagram illustrating hardware/software components of a model developer 150 in accordance with embodiments of the disclosed technology. In certain implementations, the model developer 150 can be hosted on a computing device separate from the computing device 102 (FIG. 1A). For example, the model developer 150 may be hosted on a remote server (not shown) in a data center. In other implementations, the model developer 150 may be hosted on the computing device 102 and/or other suitable locations.

As shown in FIG. 2, the model developer 150 can be configured to identify correlations between emojis 112 and various environmental parameters based on training datasets 121 having used emojis 112′ and corresponding context data 130′. In certain embodiments, the model developer 150 can be configured to utilize a “neural network” or “artificial neural network” configured to “learn” or progressively improve performance of tasks by studying known examples. In certain implementations, a neural network can include multiple layers of objects generally refers to as “neurons” or “artificial neurons.” Each neuron can be configured to perform a function, such as a non-linear activation function, based on one or more inputs via corresponding connections. Artificial neurons and connections typically have a contribution value that adjusts as learning proceeds. The contribution value increases or decreases a strength of an input at a connection. Typically, artificial neurons are organized in layers. Different layers may perform different kinds of transformations on respective inputs. Signals typically travel from an input layer, to an output layer, possibly after traversing one or more intermediate layers. Thus, by using a neural network, the model developer 150 can provide an emoji model 110 that can be used by the computing device 102 to identify one or more emojis 112 likely to be used based on various suitable environment parameters. In other embodiments, the model developer 150 can be configured to develop and/or update the emoji model 110 using other suitable techniques.

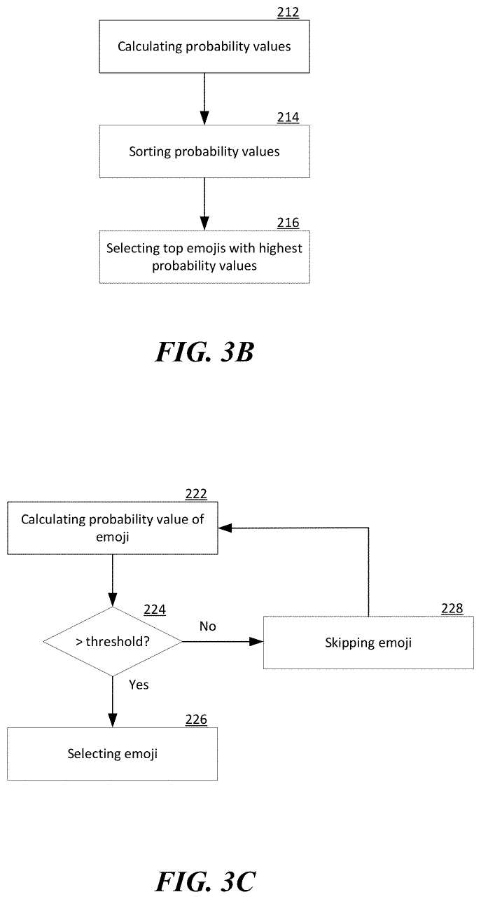

FIGS. 3A-3C are flowcharts illustrating processes of environmental context-based emoji selection in accordance with embodiments of the disclosed technology. Though the processes are described below in the context of the computing system 100, in other embodiments, the processes can also be implemented in computing systems with additional and/or different hardware/software components.

As shown in FIG. 3A, a process 200 can include receiving a request from a user to initiate an emoji picker at stage 202. The process 200 can then include retrieving context data from, for instance, the operating system 104 of FIG. 1A, at stage 204. The process 200 can then include generating a context page having selected one or more emojis based on the context data and an emoji model at stage 206. In one example, the context page can be generated to include emojis that are most frequently used based on a current date/time and/or location. In other examples, the context page can be generated to include emojis selected in other suitable manners, such as those discussed below with reference to FIGS. 3B and 3C. The process 200 can then include outputting, for instance, surfacing the generated context page to the user on a user interface at stage 208.

FIG. 3B illustrates example operations for selecting one or more emojis based on context data. As shown in FIG. 3B, the example operations can include calculating probability values of each emoji based on, for instance, weight values in an emoji model as discussed above with reference to FIGS. 1A and 1B, at stage 212. The operations can then include sorting the emojis according to the corresponding probability values at stage 214. The operations can further include selecting a number of emojis with the highest probability values as the selected emojis at stage 216.

FIG. 3C illustrates additional example operations for selecting one or more emojis based on context data. As shown in FIG. 3C, the example operations can include calculating a probability value of an emoji at stage 222. The operations can then include a decision stage 224 to determine whether the probability value exceeds a threshold value. In response to determining that the probability value exceeds the threshold value, the operations can include selecting the emoji to be added to the context page at stage 226; otherwise, the operations include skipping the emoji and return to stage 222 for additional emojis.

FIG. 4 is a computing device 300 suitable for certain components of the computing system 100 in FIGS. 1A-1C. For example, the computing device 300 can be suitable for the computing device 102 of FIGS. 1A-1C. In a very basic configuration 302, the computing device 300 can include one or more processors 304 and a system memory 306. A memory bus 308 can be used for communicating between processor 304 and system memory 306.

Depending on the desired configuration, the processor 304 can be of any type including but not limited to a microprocessor (μP), a microcontroller (μC), a digital signal processor (DSP), or any combination thereof. The processor 304 can include one more level of caching, such as a level-one cache 310 and a level-two cache 312, a processor core 314, and registers 316. An example processor core 314 can include an arithmetic logic unit (ALU), a floating-point unit (FPU), a digital signal processing core (DSP Core), or any combination thereof. An example memory controller 318 can also be used with processor 304, or in some implementations memory controller 318 can be an internal part of processor 304.

Depending on the desired configuration, the system memory 306 can be of any type including but not limited to volatile memory (such as RAM), non-volatile memory (such as ROM, flash memory, etc.) or any combination thereof. The system memory 306 can include an operating system 320 (e.g., the operating system 104 in FIG. 1A), one or more applications 322 (e.g., the application 140 and emoji picker 106 of FIG. 1A), and program data 324 (e.g., the context data 130, the emoji model 110, and the emojis 112 in FIG. 1A). This described basic configuration 302 is illustrated in FIG. 4 by those components within the inner dashed line.

The computing device 300 can have additional features or functionality, and additional interfaces to facilitate communications between basic configuration 302 and any other devices and interfaces. For example, a bus/interface controller 330 can be used to facilitate communications between the basic configuration 302 and one or more data storage devices 332 via a storage interface bus 334. The data storage devices 332 can be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data. The term “computer readable storage media” or “computer readable storage device” excludes propagated signals and communication media.

The system memory 306, removable storage devices 336, and non-removable storage devices 338 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by computing device 300. Any such computer readable storage media can be a part of computing device 300. The term “computer readable storage medium” excludes propagated signals and communication media.

The computing device 300 can also include an interface bus 340 for facilitating communication from various interface devices (e.g., output devices 342, peripheral interfaces 344, and communication devices 346) to the basic configuration 302 via bus/interface controller 330. Example output devices 342 include a graphics processing unit 348 and an audio processing unit 350, which can be configured to communicate to various external devices such as a display or speakers via one or more A/V ports 352. Example peripheral interfaces 344 include a serial interface controller 354 or a parallel interface controller 356, which can be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which can be arranged to facilitate communications with one or more other computing devices 362 over a network communication link via one or more communication ports 364.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

The computing device 300 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 300 can also be implemented as a personal computer including both laptop computer and non-laptop computer configurations.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

I/We claim:

1. A method for managing user interfaces at a computing device having a display, a processor, and a memory containing instructions executable by the processor to provide an operating system, the method comprising:
receiving, at the computing device, a user request to surface an emoji interface for selecting emojis, the emoji interface having one or more pages individually containing one or more emojis; and
in response to receiving the user request, with the processor,
retrieving, from the operating system, environmental context data of the computing device, the environmental context data including one or more environment parameters of a current date, current time, or location of the computing device; and
based on the retrieved environmental context data,
selecting one or more emojis based on an emoji model containing data representing correlations of the one or more emojis and the one or more environmental parameters;
grouping the selected one or more emojis into a context page as one of the one or more pages of the emoji interface; and
surfacing, on the display of the computing device, the emoji interface with the context page in response to the user request.

2. The method of claim 1 wherein:
the one or more pages of the emoji interface include a first page and a second page;
the first page includes one or more emojis;
the second page includes one or more other emojis different than the emojis in the first page; and
the context page includes at least one of the emojis from the first page and at least one of the other emojis from the second page.

3. The method of claim 1 wherein retrieving the environmental context data includes one or more of:
retrieving data representing a current system time of the computing device from the operating system of the computing device; or
retrieving data representing a current system time of a cellular network in communication with the computing device.

4. The method of claim 1 wherein:
the computing device further includes a global positioning system (GPS) module; and
retrieving the environmental context data includes querying the GPS module for a current geological location of the computing device.

5. The method of claim 1 wherein selecting the one or more emojis includes determining, based on the emoji model, the one or more emojis having highest frequency of use than other emojis in the emoji interface at the current date, current time, or location of the computing device.

6. The method of claim 1 wherein:
the correlations in the emoji model are represented by weight values corresponding to the individual environmental parameters for the individual emojis; and
the method further includes, for one of the emojis:
calculating a probability that the one of the emojis is likely be used by deriving a sum of products of numerical values of the current date, current time, or location and corresponding weight values;
determining whether the derived sum exceeds a threshold; and
in response to determining that the derived sum exceeds a threshold, marking the one of the emojis as one of the selected one or more emojis.

7. The method of claim 1 wherein:
the correlations in the emoji model are represented by weight values corresponding to the individual environmental parameters for the individual emojis; and
the method further includes, for one of the emojis:
calculating a probability that the one of the emojis is likely be used by deriving a sum of products of numerical values of the current date, current time, or location and corresponding weight values;
determining whether the derived sum exceeds a threshold; and
in response to determining that the derived sum does not exceed a threshold, marking the one of the emojis as not to be included in the context page.

8. The method of claim 1 wherein:
the environmental parameters include both a current date and location of the computing device; and
selecting the one or more emojis includes selecting the one or more emojis based on both the current date and location of the computing device.

9. The method of claim 1 wherein:
the environmental context data further includes data representing a calendar item accessible by the computing device; and
selecting the one or more emojis includes selecting the one or more emojis corresponding to an activity indicated in the calendar item based on the emoji model.

10. A computing device, comprising:
a display;
a processor; and
a memory operatively coupled to the processor, the memory containing an emoji model representing correlations between individual emojis and one or more environmental parameters of a date, a time, or a location of the computing device, the memory also having instructions executable by the processor to provide an operating system and to cause the computing device to:
retrieve, from the operating system, current values of the one or more environment parameters in response to a request from a user for surfacing an emoji interface; and
based on the retrieved current values of the environmental parameters, select one or more of the emojis based on the correlations in the emoji model as being likely to be used by the user via the emoji interface; and
surface, on the display of the computing device, the emoji interface with the selected one or more of the emojis in response to the user request.

11. The computing device of claim 10 wherein to select the one or more emojis includes to determine, based on the emoji model, the one or more emojis having highest frequency of use in all of the emojis at the current values of date, time, or location of the computing device.

12. The computing device of claim 10 wherein:
the correlations in the emoji model are represented by weight values corresponding to the individual environmental parameters for the individual emojis; and
the memory includes additional instructions executable by the processor to cause the computing device to:
derive a sum of products of the current values of date, time, or location and corresponding weight values;
determine whether the derived sum exceeds a threshold; and
in response to determining that the derived sum exceeds a threshold, mark the one of the emojis as one of the selected one or more emojis.

13. The computing device of claim 10 wherein:
the correlations in the emoji model are represented by weight values corresponding to the individual environmental parameters for the individual emojis; and
the memory includes additional instructions executable by the processor to cause the computing device to:
derive a sum of products of the current values of date, time, or location and corresponding weight values;
determine whether the derived sum exceeds a threshold; and
in response to determining that the derived sum exceeds a threshold, mark the one of the emojis as not to be included in the context page.

14. The computing device of claim 10 wherein:
the environmental parameters include both a date and a location of the computing device; and
selecting the one or more emojis includes selecting the one or more emojis based on both the current date and location of the computing device.

15. The computing device of claim 10 wherein:
the emoji model further includes data representing a correlation between an activity indicated in a calendar item accessible by the computing device and an emoji; and
selecting the one or more emojis includes selecting the one or more emojis corresponding to the activity indicated in the calendar item based on the emoji model.

16. A method for managing user interfaces at a computing device having a display, a processor, and a memory containing instructions executable by the processor to provide an operating system, the method comprising:
receiving, at the computing device, a user request to surface an emoji interface for selecting emojis, the emoji interface having one or more pages individually containing one or more emojis; and
in response to receiving the user request, with the processor,
retrieving, from the operating system, current values of one or more of a date, a time, or a location of the computing device; and
based on the retrieved current values,
identifying one or more of the one or more emojis having highest frequency of use among all the one or more emojis in the emoji interface at the current values of date, time, or location of the computing device;
grouping the identified one or more emojis into a page and appending the page to the one or more pages of the emoji interface; and
surfacing, on the display of the computing device, the emoji interface with the appended page in response to the user request.

17. The method of claim 16 wherein identifying the one or more of the one or more emojis includes identifying the one or more of the emojis based on the retrieved current values and an emoji model containing data representing correlations of the one or more emojis and the one or more environmental parameters.

18. The method of claim 16 wherein identifying the one or more of the one or more emojis includes identifying the one or more of the emojis based on the retrieved current values and an emoji model containing data representing weight values corresponding to the individual environmental parameters for the individual emojis.

19. The method of claim 16 wherein identifying the one or more of the one or more emojis includes, for each of the one or more emojis:
calculating a probability value that one of the emojis is likely be used by deriving a sum of products of the current values of date, time, or location and corresponding weight values included in an emoji model;
sorting the one or more emojis according to respectively probability values; and
selecting the one or more of the one or more emojis having highest probability values from the sorted one or more emojis.

20. The method of claim 16, further comprising:
removing, from the emoji interface, one or more of the one or more emojis based on the retrieved current value of location of the computing device according to a rule contained in the memory.
